(19) United States
(12) Patent Application Publication
(10) Pub. No.: US 2019/0216119 A1
(43) Pub. Date: Jul. 18, 2019

(54) Liquid Sweetener Compositions

(71) Applicant: Merisant US, Inc., Chicago, IL (US)

(72) Inventor: David Joseph Sitko, Chicago, IL (US)

(21) Appl. No.: 16/251,759

(22) Filed: Jan. 18, 2019

Related U.S. Application Data
(60) Provisional application No. 62/618,863, filed on Jan. 18, 2018.

(51) Int. Cl. A23L 27/30; A23L 29/30

(52) U.S. Cl. CPC A23L 27/36; A23L 29/30; A23V 2002/00; A23V 2300/26; A23V 2250/262; A23V 2250/21; A23V 2200/132

(57) ABSTRACT

The disclosure provides sweetener compositions of high intensity sweeteners, such as steviol glycosides and monk fruit extract, together with syrups and/or carbohydrates.

### CROSS REFERENCE TO RELATED APPLICATIONS

This application claims the benefit of priority of U.S. Provisional Patent Application No. 62/618,863, filed Jan. 18, 2018, which is hereby incorporated by reference in its entirety.

### BACKGROUND OF THE INVENTION

### Field of the Invention

The disclosure provides sweetener compositions of high intensity sweeteners, such as steviol glycosides and monk fruit extract, together with syrups and/or carbohydrates.

### Description of Related Art

The species Stevia rebaudiana (“Stevia”) has been the subject of considerable research and development efforts directed at the purification of certain naturally occurring sweet glycosides of Stevia that have potential as non-caloric sweeteners. Sweet glycosides that may be extracted from Stevia include all reported rebaudiosides (i.e., rebaudiosides A, B, C, D, E, and F, M, N and O), as well as stevioside, and the dulcosides, e.g., dulcosides A and B.

Non-caloric or low-caloric sweeteners can be delivered to consumers through solid or liquid applications. For example, packets of dry sweeteners are commonly used for sweetening coffee or other consumable products by sprinkling the contents of the packages over such products. Non caloric or low caloric sweeteners can also be delivered in liquid form. For example, reduced calorie forms of honey and agave are desirable and can be delivered to consumers in conventional glass or plastic containers. Liquid sweeteners also have utility as a means of delivering sweetness to other food and beverage products.

Thus, there is an interest in improving natural and other syrups and other liquid carbohydrate formulations so that they have less calories or so that a reduced amount of the sweetener may be used without sacrificing taste. The caloric content of natural and other syrups may be reduced by decreasing the solids content of the syrup, which in turn reduces the caloric content. Similarly, the caloric content of the liquid carbohydrate formulations may be reduced by decreasing the total amount of the carbohydrate in the formulation. When the solids are removed, gums have been added to create texture, and natural or artificial flavors have been added to create or enhance the flavor. Formulations made in this manner have many undesirable attributes. For example, these gum based low calorie syrups have an unnatural mouth feel (e.g., they are slimy, gummy, or thin), minimal aroma, and do not taste like natural syrups. In turn, high intensity sweeteners have been used to adjust the sweetness of the syrup, however, the resulting products lack certain desirable characteristics of the natural syrups. For example, rebaudiosides, such as rebaudiosides A, B, C, D, E, F, M, N and O, stevioside, and dulcosides A and B sometimes cannot be dissolved in a syrup, and when these high intensity sweeteners are used to prepare modified syrup compositions, the resulting modified syrup compositions become cloudy after prolonged storage, a characteristic which is not expected by or appealing to consumers. Sweetener products typically are shipped to food service providers where they are used for a prolonged period of time, or they are located on grocery or mass merchandiser shelves where they are stored for a prolonged period of time. Such products are typically expected to have shelf life of at least 1 to 2 years. The ease of transportation and visual stability of such products is thus crucial.

### SUMMARY OF THE INVENTION

Steviol glycosides are desired for use in sugar-replacing or sugar-reducing sweetener applications for their combination of sweetness potency (about 200-400 times sweeter than sugar) and flavor profiles. Utilization of many steviol glycosides and combinations thereof in liquid applications is severely hampered by their poor solubility. Tabletop sweeteners have traditionally relied on using steviol glycosides at the maximum concentration level attainable in aqueous solution. This also requires that the tabletop sweetener formulation is diluted (i.e., has a significant amount of additional water) to properly dissolve the steviol glycoside.

The inventors have found improved sweetener compositions, particularly the sweetener compositions comprising one or more syrups, that address these issues.

Thus, one aspect of the disclosure provides a sweetener composition including:
(a) about 0.1-4.5% by weight of one or more steviol glycosides;
(b) about 0.1-4.5% by weight of Siraitia grosvenorii fruit (monk fruit) extract; and
(c) about 90-98% by weight of one or more syrups.

Another aspect of the disclosure provides a sweetener composition including:
(a) about 0.1-4.5% by weight of one or more steviol glycosides;
(b) about 0.02-2.7% by weight of one or more of mogrosides; and
(c) about 90-98% by weight of one or more syrups.

In a further aspect, the disclosure provides methods for preparing the sweetener compositions of the disclosure. For example, in one embodiment, such methods include:
(a) providing an aqueous solution comprising about 5-45% by weight of one or more steviol glycosides and about 5-45% by weight of Siraitia grosvenorii fruit extract; and
(b) adding a portion of the aqueous solution to a syrup solution.

In another embodiment, such methods include:
(a) providing an aqueous solution comprising about 5-45% by weight of one or more steviol glycosides and about 1-27% by weight of one or more of mogrosides; and
(b) adding a portion of the aqueous solution to a syrup or a carbohydrate solution.

In another aspect, the sweetener compositions of the disclosure may be provided or, for example, sold as the sweetener compositions of the disclosure alone. In addition, in another aspect, these sweetener compositions of the disclosure may be incorporated into other food products to adjust the sweetness of those food products. Such food products typically have low water contents (<40% by weight). Examples of such products include, but are not limited to, yogurt, jelly, jam, fruit fillings for pies, nutrition bars, icings, mayonnaise, ketchup, confectionary and compound coatings.

### BRIEF DESCRIPTION OF THE DRAWINGS

The accompanying drawings are included to provide a further understanding of the compositions and methods of the disclosure, and are incorporated in and constitute a part of this specification. The drawings illustrate one or more embodiment(s) of the disclosure, and together with the description, serve to explain the principles of the disclosure.

FIG. 1 illustrates the stability studies of Example 1. (A) stability results of an aqueous solution of “Delta,” which is a stevia leaf extract comprising approximately 54% Reb-D, 41% Reb-A, and 5% Reb-B, with and without “Monk,” which is a monk fruit extract containing 50 wt % mogroside (B) stability results of an aqueous solution of “Reb-M,” which is a stevia leaf extract comprising approximately 81% Reb-M, 10% Reb-D, 7% Reb-A, and 2% Reb-B, with and without “Monk.” All percentages are wt % in water.

FIG. 2 illustrates the stability studies of the compositions of Example 2 after 24 weeks. (A) stability results of compositions comprising 2.2 wt % stevia/0.8 wt % monk in organic agave nectar syrup. (B) stability results of compositions comprising 3 wt % stevia in organic agave nectar syrup. (C) stability results of compositions comprising 2.2 wt % stevia in organic agave nectar syrup.

### DETAILED DESCRIPTION OF THE INVENTION

Before the disclosed materials and methods are described, it is to be understood that the aspects described herein are not limited to specific embodiments, or configurations, and as such can, of course, vary. It is also to be understood that the terminology used herein is for the purpose of describing particular aspects only and, unless specifically defined herein, is not intended to be limiting.

In view of the present disclosure, the active materials and methods described herein can be configured by the person of ordinary skill in the art to meet the desired need. In general, the disclosed materials and methods provide improvements in sweetener compositions. For example, in certain aspects, the disclosure provides improved sweetener compositions, particularly the sweetener compositions comprising one or more syrups and/or carbohydrates. For example, in certain aspects, the sweetener compositions of the disclosure have improved appearance, taste, and improved shelf-life. In certain aspects, the sweetener compositions have clear and homogeneous appearance, even after several months if not years. For example, the sweetener compositions allow for one or more steviol glycosides to remain in syrup or in carbohydrate solution for a long period of time without becoming cloudy (e.g., without the sweetening component crystallizing out of the solution) making the sweetener compositions more appealing to consumers. In addition, the steviol glycoside component provides additional sweetness to the sweetener compositions, making it further appealing to the consumers due to the improved taste or lower calorie consumption (e.g., by consumers using less of the sweetener compositions yet maintaining the desired sweetness).

As used herein, the term “clear” means substantially free of undissolved steviol glycosides, in particular rebaudiosides, upon visual inspection by a person of skill in the art. For example, the sweetener compositions of the disclosure are homogenous showing a substantially complete dissolution of the rebaudiosides in water, and no interface between the aqueous solution and the syrup. In certain embodiments, the term “substantially complete dissolution” means no solid material is apparent upon visual inspection, such as no cloudiness or larger particles in the composition or no sedimentation.

One aspect of the disclosure provides a sweetener composition comprising:

(a) about 0.1-4.5% by weight of one or more steviol glycosides;

(b) about 0.1-4.5% by weight of Siraitia grosvenorii fruit (monk fruit) extract; and

(c) about 90-98% by weight of one or more syrups.

Another aspect of the disclosure provides a sweetener composition comprising:

(a) about 0.1-4.5% by weight of one or more steviol glycosides;

(b) about 0.02-2.7% by weight of one or more of mogrosides; and

(c) about 90-98% by weight of one or more syrups.

The sweetener compositions of the disclosure comprise one or more steviol glycosides. Generally, steviol glycosides are found in an extract or extracts of Stevia rebaudiana (Bertoni) plant. The steviol glycosides may also be obtained by other means, including but not limited to, chemical or enzymatic modification of certain steviol glycoside components to obtain other steviol glycoside components, or production by fermentation processes. These steviol glycosides can be up to 300 times sweeter than sucrose. Steviol glycosides of particular interest for their high level of sweetness and/or low level of bitterness include, but are not limited to, rebaudioside A, rebaudioside B, rebaudioside C, rebaudioside D, rebaudioside E, rebaudioside F, rebaudioside M, rebaudioside N, and rebaudioside O, other steviol glycosides, stevioside, dulcoside A, dulcoside B, and mixtures thereof. In some embodiments, one or more steviol glycosides are selected from rebaudioside A, rebaudioside B, rebaudioside C, rebaudioside D, rebaudioside E, rebaudioside F, rebaudioside M, rebaudioside N, rebaudioside O, and a mixture thereof. In some embodiments, one or more steviol glycosides are selected from rebaudioside A, rebaudioside B, rebaudioside D, rebaudioside M, and a mixture thereof. In some embodiment of the disclosure, the one or more steviol glycosides is a blend of steviol glycosides, including one or more rebaudiosides.

For example, in one embodiment, the steviol glycoside is rebaudioside A. In some embodiments of the disclosure, the steviol glycoside includes a large percentage (e.g., more than 40%, or 50%, or 60%, or 70%, or 75%, or 80%, or 85%, or 90%, or 95%, or 99% by weight of the one or more steviol glycosides) of rebaudioside A. In other embodiments, the one or more steviol glycoside includes a large percentage of a blend of rebaudioside A and other rebaudiosides.

In another embodiment, the rebaudioside A purity is greater than 70%, or 75%, or 80%, or 85%, or 90%, or 95% by weight. In another embodiment, rebaudioside A purity is greater than 97% by weight.

In another embodiment, the steviol glycoside is free or substantially free of (e.g., less than 5 wt % or less than 2 wt % or less than 1 wt %) rebaudioside A.

In one embodiment, the one or more steviol glycosides is rebaudioside B or rebaudioside D. Some embodiments of the present disclosure comprise one or more steviol glycosides that include a large percentage (e.g., more than 40%, or 50%, or 60%, or 70%, or 75%, or 80%, or 85%, or 90%, or 95%, or 99% by weight of the one or more steviol glycosides) of rebaudioside B. Other embodiments comprise the one or more steviol glycosides that include a large percentage (e.g., more than 50%, or 60%, or 70%, or 75%, or 80%, or 85%, or 90%, or 95%, or 99% by weight of the one or more steviol glycosides) of rebaudioside D. Yet other embodiments comprise the one or more steviol glycosides include a large percentage of a blend of rebaudioside B and rebaudioside D.

In one embodiment, the one or more steviol glycosides is rebaudioside D. In some embodiments of the disclosure, the steviol glycosides include a large percentage (e.g., more than 40%, or 50%, or 60%, or 70%, or 75%, or 80%, or 85%, or 90%, or 95%, or 99% by weight of the one or more steviol glycosides) of rebaudioside D. In some embodiments of the disclosure, the steviol glycoside is rebaudioside D, and contains less than about 10 wt %, or less than about 5 wt %, or less than about 3 wt %, or less than about 2 wt %, or less than about 1 wt %, or less than about 0.5 wt %, or less than about 0.1 wt %, or is essentially free of other rebaudiosides (e.g., rebaudioside A, B, C, E, F, M, N, and/or O). In other embodiments, the one or more steviol glycosides include a large percentage of a blend of rebaudioside D and other rebaudiosides.

In one embodiment, the one or more steviol glycosides is a mixture of rebaudioside D and rebaudioside M and optionally comprises one or more of rebaudioside A, rebaudioside B, rebaudioside C, rebaudioside E, rebaudioside F, rebaudioside N, rebaudioside O, and mixtures thereof. In one embodiment, the one or more steviol glycosides is a mixture of rebaudioside D and rebaudioside M and optionally comprises one or more of rebaudioside B, rebaudioside C, rebaudioside E, rebaudioside F, rebaudioside N, rebaudioside O, and mixtures thereof. In some embodiments of the disclosure, rebaudioside D and rebaudioside M are present in an amount of at least 50 weight %, or at least 60 weight %, or at least 70 weight %, or at least 80 weight % based on the total weight of steviol glycosides.

In one embodiment, the one or more steviol glycosides is rebaudioside M. In some embodiments of the disclosure, the steviol glycosides include a large percentage (e.g., more than 40%, or 50%, or 60%, or 70%, or 75%, or 80%, or 85%, or 90%, or 95%, or 99% by weight of the one or more steviol glycosides) of rebaudioside M. In some embodiments of the disclosure, the steviol glycoside is rebaudioside M, and contains less than about 10 wt %, or less than about 5 wt %, or less than about 3 wt %, or less than about 2 wt %, or less than about 1 wt %, or less than about 0.5 wt %, or less than about 0.1 wt %, or is essentially free of other rebaudiosides (e.g., rebaudioside A, B, C, D, E, F, N, and/or O). In other embodiments, the one or more steviol glycosides include a large percentage of a blend of rebaudioside M and other rebaudiosides.

Similarly, the sweetener compositions of the disclosure may comprise other steviol glycosides, e.g., rebaudioside C, rebaudioside E, rebaudioside F, rebaudioside M, rebaudioside N, rebaudioside O, stevioside, dulcoside A, and dulcoside B, or may be made with blends of such glycosides. Thus, in certain embodiments of this disclosure, the high level of purity of a particular rebaudioside in the sweetener composition is not significant. Commercially available steviol glycoside blends may also be used.

In one embodiment, the one or more steviol glycosides is a mixture of two or more of: rebaudioside A, rebaudioside B, rebaudioside D, and rebaudioside M, and wherein rebaudioside D is present in an amount of at least 40 weight %, or at least 50 weight % based on the total weight of steviol glycosides. In one embodiment, the one or more steviol glycosides is a mixture of two or more of: rebaudioside B, rebaudioside D, and rebaudioside M, and wherein rebaudioside D is present in an amount of at least 40 weight %, or at least 50 weight % based on the total weight of steviol glycosides. In one embodiment, the one or more steviol glycosides is a mixture of two or more of: rebaudioside A, rebaudioside B, rebaudioside D, and rebaudioside M, and wherein rebaudioside M is present in an amount of at least 50 weight %, or at least 60 weight %, or at least 70 weight %, or at least 80 weight % based on the total weight of steviol glycosides. In one embodiment, the one or more steviol glycosides is a mixture of two or more of: rebaudioside B, rebaudioside D, and rebaudioside M, and wherein rebaudioside M is present in an amount of at least 50 weight %, or at least 60 weight %, or at least 70 weight %, or at least 80 weight % based on the total weight of steviol glycosides.

The inventors have also found that a specific combination of rebaudiosides, e.g., rebaudioside A, rebaudioside D, and rebaudioside M present in a particular ratio, results in products having improved appearance, taste, and shelf-life. Thus, in certain embodiments, the one or more steviol glycosides is a mixture of rebaudioside A, rebaudioside D, and rebaudioside M, wherein the ratio of rebaudioside A to the sum of rebaudioside D and rebaudioside M is about 1:1 to about 3:1, and wherein the ratio of rebaudioside M to rebaudioside D is about 1:2.3 to about 2.3:1.

For example, in one embodiment, the ratio of rebaudioside A to the sum of rebaudioside D and rebaudioside M is about 1:1 to about 3:1. In certain embodiments, the ratio of rebaudioside A to the sum of rebaudioside D and rebaudioside M is about 1.1:1 to about 3:1, or about 1.25:1 to about 3:1, or about 1.5:1 to about 3:1, or about 1.75:1 to about 3:1, 1:1 to about 2:1, or about 1.25:1 to about 2:1, or about 1.5:1 to about 2:1, or about 1.75:1 to about 2:1, or about 1:1 to about 1.8:1, or about 1:1 to about 1.75:1, or about 1:1 to about 1.5:1, or about 1:1 to about 1.25:1.

For example, in another embodiment, the ratio of rebaudioside M to rebaudioside D is about 1:2.3 to about 2.3:1. In certain embodiments, the ratio of rebaudioside M to rebaudioside D is about 1:1.5 to about 2.3:1, or about 1:1.5 to about 1.5:1, or about 1:1.2 to about 1.2:1, or about 1:1.25 to about 1.25:1, or about 1.1:1 to about 1:1, or about 1.2:1 to about 1:1, or about 1.3:1 to about 1:1, or about 1.4:1 to about 1:1, or about 1.5:1 to about 1:1, or about 2:1 to about 1:1, or about 2.3:1 to about 1:1, or about 1:1 to about 2.3:1, or about 1:1 to about 2:1, or about 1:1 to about 1.5:1, or about 1:1 to about 1.4:1, or about 1:1 to about 1.3:1, or about 1:1 to about 1.2:1.

In some embodiments, the ratio of rebaudioside A to rebaudioside D to rebaudioside M is about 10:2:3. In some embodiments, the ratio of rebaudioside A to rebaudioside D to rebaudioside M is about 10:3:3. In some embodiments, the ratio of rebaudioside A to rebaudioside D to rebaudioside M is or about 10:2:4. In some embodiments, the ratio of rebaudioside A to rebaudioside D to rebaudioside M is about 10:3:4. In some embodiments, the ratio of rebaudioside A to rebaudioside D to rebaudioside M is about 10:4:4. In some embodiments, the ratio of rebaudioside A to rebaudioside D to rebaudioside M is about 10:4:5. In some embodiments, the ratio of rebaudioside A to rebaudioside D to rebaudioside M is about 10:4:3. In some embodiments, the ratio of rebaudioside A to rebaudioside D to rebaudioside M is about 10:3:7. In some embodiments, the ratio of rebaudioside A to rebaudioside D to rebaudioside M is about 10:7:3. In some embodiments, the ratio of rebaudioside A to rebaudioside D to rebaudioside M is about 10:1:2.3. In some embodiments, the ratio of rebaudioside A to rebaudioside D to rebaudioside M is about 10:2.3:1. In some embodiments, the ratio of rebaudioside A to rebaudioside D to rebaudioside M is about 10:2.4:3.

In certain embodiments, rebaudioside A is present in about 50% to about 75% by weight based on the total weight of rebaudioside A, rebaudioside D, and rebaudioside M. For example, rebaudioside A is present in about 50 wt % to about 70 wt %, or 50 wt % to about 65 wt %, or about 50 wt % to about 63 wt %, or about 50 wt % to about 60 wt %, or about 50 wt % to about 57 wt %, or about 50 wt % to about 55 wt %, or 52 wt % to about 75 wt %, or 52 wt % to about 70 wt %, or 52 wt % to about 65 wt %, or about 52 wt % to about 63 wt %, or about 52 wt % to about 60 wt %, or about 52 wt % to about 57 wt %, or about 52 wt % to about 55 wt %, or about 55 wt % to about 75 wt %, or about 55 wt % to about 70 wt %, or about 55 wt % to about 67 wt %, or about 55 wt % to about 65 wt %, or about 55 wt % to about 63 wt %, or about 55 wt % to about 60 wt %, or about 55 wt % to about 57 wt %, or about 60 wt % to about 75 wt %, or about 60 wt % to about 70 wt %, or about 60 wt % to about 67 wt %, or about 60 wt % to about 65 wt %, or about 60 wt % to about 63 wt %, or about 63 wt % to about 67 wt %, or about 54 wt % to about 57 wt %, based on the total weight of rebaudioside A, rebaudioside D, and rebaudioside M.

In certain embodiments, rebaudioside D is present in about 7.5% to about 35% by weight based on the total weight of rebaudioside A, rebaudioside D, and rebaudioside M. For example, rebaudioside D is present in about 7.5 wt % to about 30 wt %, or about 7.5 wt % to about 25 wt %, or about 7.5 wt % to about 20 wt %, or about 7.5 wt % to about 18 wt %, or about 10 wt % to about 35 wt %, or about 10 wt % to about 30 wt %, or about 10 wt % to about 25 wt %, or about 10 wt % to about 20 wt %, or about 10 wt % to about 18 wt %, or about 10 wt % to about 15 wt %, or about 15 wt % to about 35 wt %, or about 15 wt % to about 30 wt %, or about 15 wt % to about 25 wt %, or about 15 wt % to about 20 wt %, or about 15 wt % to about 18 wt %, or about 18 wt % to about 35 wt %, or about 18 wt % to about 30 wt %, or about 18 wt % to about 25 wt %, or about 18 wt % to about 20 wt %, based on the total weight of rebaudioside A, rebaudioside D, and rebaudioside M.

In certain embodiments, rebaudioside M is present in about 7.5% to about 35% by weight based on the total weight of rebaudioside A, rebaudioside D, and rebaudioside M. For example, rebaudioside M is present in about 7.5 wt % to about 30 wt %, or about 7.5 wt % to about 28 wt %, or about 7.5 wt % to about 25 wt %, or about 7.5 wt % to about 20 wt %, or about 7.5 wt % to about 15 wt %, or about 10 wt % to about 35 wt %, or about 10 wt % to about 30 wt %, or about 10 wt % to about 28 wt %, or about 10 wt % to about 25 wt %, or about 10 wt % to about 20 wt %, or about 10 wt % to about 15 wt %, or about 20 wt % to about 35 wt %, or about 20 wt % to about 30 wt %, or about 20 wt % to about 28 wt %, or about 20 wt % to about 25 wt %, or about 22 wt % to about 35 wt %, or about 22 wt % to about 30 wt %, or about 22 wt % to about 28 wt %, or about 22 wt % to about 25 wt %, or about 25 wt % to about 35 wt %, or about 25 wt % to about 30 wt %, or about 25 wt % to about 28 wt %, or about 30 wt % to about 35 wt %, based on the total weight of rebaudioside A, rebaudioside D, and rebaudioside M.

While additional components can be present in the one or more steviol glycosides as described above, in certain desirable embodiments, the chief constituents in the one or more steviol glycosides are rebaudioside A, rebaudioside D, and rebaudioside M. Accordingly, in certain embodiments as otherwise described herein, the total amount of rebaudioside A, rebaudioside D, and rebaudioside M in the one or more steviol glycosides is at least about 75 wt %, or at least about 80 wt %, or at least about 85 wt %, or at least about 90 wt %, or at least about 95 wt %, or at least about 98 wt %, or at least about 99 wt % of the one or more steviol glycosides.

In one embodiment of the disclosure, the one or more steviol glycosides is present in amount of about 0.1 to about 4.5 wt % based on the total weight of the composition; for example, e.g., about 0.1 to about 4 wt %; or about 0.1 to about 3 wt %; or about 0.1 to about 2.5 wt %; or about 0.1 to about 2 wt %; or about 0.1 to about 1.5 wt %; or about 0.1 to about 1 wt %; or about 0.5 to about 4.5 wt %; or about 0.5 to about 4 wt %; or about 0.5 to about 3 wt %; or about 0.5 to about 2.5 wt %; or about 0.5 to about 2 wt %; or about 0.5 to about 1.5 wt %; or about 0.5 to about 1 wt %; or about 1 to about 4.5 wt %; or about 1 to about 4 wt %; or about 1 to about 3 wt %; or about 1 to about 2.5 wt %; or about 1 to about 2 wt %; or about 1 to about 1.5 wt %; or about 1.5 to about 4.5 wt %; or about 1.5 to about 4 wt %; or about 1.5 to about 3.5 wt %; or about 1.5 to about 3 wt %; or about 1.5 to about 2.5 wt %; or about 1.5 to about 2 wt %; or about 2 to about 3 wt % based on the total weight of the composition.

The sweetener compositions of the disclosure may also comprise one or more syrups.

As used herein, the term “syrup” means a solution, preferably a viscous solution, having from about 60% to 85% by weight, of carbohydrate solids and the balance primarily water, and having viscosity higher than that of water at 20° C. (i.e., higher than 1 mPa·s at 20° C.). In certain embodiments, the syrup as described herein is a solution having viscosity of at least 50 mPa·s at 20° C. The carbohydrate solids that make up the syrup as disclosed herein may be carbohydrate solids naturally present in the syrup, for example such as glucose and fructose present in honey. The carbohydrate solids that make up the syrup as disclosed herein may also be externally added, such as glucose and fructose present in invert sugar syrup. The carbohydrate solids that make up the syrup as disclosed herein may also comprise a combination of carbohydrate solids naturally present in the syrup and externally added carbohydrate solids. Likewise, the balance of water that makes up the syrup as disclosed herein may be naturally present in the syrup, such as water present in honey, or externally added, such as the water present in diluted honey.

The following are non-limiting examples of solutions that can serve as the syrup as disclosed herein: (i) agave syrup having about 75% naturally present carbohydrate solids and about 25% naturally present water; (ii) honey having about 82% naturally present carbohydrate solids and about 18% naturally present water; (iii) diluted honey having about 75% naturally present carbohydrate solids, about 16.5% naturally present water, and about 8.5% externally added water; and (iv) sweetened honey having about 70% naturally present carbohydrate solids, about 15.4% naturally present water, about 5% externally added fructose, and about 9.6% externally added water.

Suitable syrups for use herein are made up primarily of a mixture of water and glucose, fructose, fructo oligosaccharide, galacto oligosaccharide, inulin, and various other monosaccharides, oligosaccharides, polysaccharides, and/or oligoglucoses. Common examples of compositions which could function as the syrup component include invert sugar syrup, evaporated cane juice syrups (liquid cane syrups), corn syrup (with varying ratios of glucose to fructose), and natural syrups such as fruit syrups, tree syrups, bee syrups, tuber syrups, grass syrups, and mixtures thereof. An invert sugar syrup refers to glucose-fructose based syrup that results from the hydrolysis of sucrose into glucose and fructose. The syrups may include levels of solids such as particles of fruit.

In one embodiment, the syrup of the disclosure is selected from fruit syrups, tree syrups, bee syrups, tuber syrups, grass syrups, and mixtures thereof. In another embodiment, the syrup is selected from the group consisting of agave syrup, invert sugar syrup, sugarcane syrup, honey, maple syrup, almond syrup, banana syrup, blueberry syrup, cherry syrup, coconut syrup, hazelnut syrup, kiwi syrup, lemon syrup, mango syrup, orange syrup, peach syrup, strawberry syrup, vanilla syrup, raspberry syrup, apple syrup, blackberry syrup, pineapple syrup, molasses, and mixtures thereof. In another embodiment, the syrup is agave syrup, invert sugar syrup, sugarcane syrup, honey, coconut syrup, maple syrup, and mixtures thereof. In some embodiments, the syrup is agave syrup. In some embodiments, the syrup is honey.

In one embodiment of the sweetener composition of the disclosure, the one or more syrups is present in amount of about 90 to about 98 wt % based on the total weight of the composition; for example, e.g., about 90 to about 97 wt %; or about 90 to about 95 wt %; or about 90 to about 93 wt %; or about 93 to about 98 wt %; or about 93 to about 97 wt %; or about 93 to about 95 wt %; or about 95 to about 98 wt %; or about 95 to about 97 wt %.

In one embodiment of the disclosure, the syrup comprises a combination of one or more natural syrups and one or more added carbohydrates. Suitable examples of added carbohydrates include, but are not limited to, monosaccharides (e.g., glucose, fructose, allulose, etc.), disaccharides (e.g.; sucrose, maltose, etc.), and sugar alcohols (e.g., erythritol, xylitol, sorbitol, maltitol, mannitol, isomalt, and mixtures thereof). In one embodiment of the sweetener composition of the disclosure, the syrup including the combination of one or more natural syrups and one or more added carbohydrates is present in amount of about 90 to about 98 wt % based on the total weight of the composition as described herein.

The sweetener compositions of the disclosure may also include extracts of the fruit of the Siraitia grosvenorii (monk fruit or luo han guo or lo han kuo). Siraitia grosvenorii extract (monk fruit extract) may comprise one or more mogrosides, which are cucurbitane derivatives. Such mogrosides may be selected from mogroside II A₁, mogroside II B, mogroside II E, mogroside III, mogroside III A₂, mogroside IV, mogroside V, mogroside VI, 11-oxo-mogroside V, 7-oxo-mogroside V, isomogroside V, and mixtures thereof. In some embodiments, Siraitia grosvenorii extract (monk fruit extract) comprises about 20 to about 60% by weight, or about 30 to about 60 wt %, or about 40 to about 60 wt % of mogroside V.

In some embodiments of the sweetener compositions of the disclosure, the Siraitia grosvenorii fruit extract is present in amount of about 0.1 to about 4.5 wt % based on the total weight of the composition; for example, e.g., about 0.1 to about 4 wt %; or about 0.1 to about 3 wt %; or about 0.1 to about 2.5 wt %; or about 0.1 to about 2 wt %; or about 0.1 to about 1.5 wt %; or about 0.1 to about 1 wt %; or about 0.5 to about 4.5 wt %; or about 0.5 to about 4 wt %; or about 0.5 to about 3 wt %; or about 0.5 to about 2.5 wt %; or about 0.5 to about 2 wt %; or about 0.5 to about 1.5 wt %; or about 0.5 to about 1 wt %; or about 1 to about 4.5 wt %; or about 1 to about 4 wt %; or about 1 to about 3 wt %; or about 1 to about 2.5 wt %; or about 1 to about 2 wt %; or about 1 to about 1.5 wt %; or about 1.5 to about 4.5 wt %; or about 1.5 to about 4 wt %; or about 1.5 to about 3.5 wt %; or about 1.5 to about 3 wt %; or about 1.5 to about 2.5 wt %; or about 1.5 to about 2 wt %; or about 2 to about 3 wt % based on the total weight of the composition.

In some embodiments, wherein the weight ratio of the one or more steviol glycoside to Siraitia grosvenorii fruit extract is between about 3:1 to about 1:3, or about 3:1 to about 1:2, or about 3:1 to about 1:1, or about 2:1 to about 1:3, or about 1:1 to about 1:3, or about 2:1 to about 1:2, or about 1:1 to about 1:2, or about 2:1 to about 1:1.

In some embodiments, the combined content of one or more steviol glycosides, Siraitia grosvenorii fruit extract, and one or more syrups is at least about 92% by weight of the sweetener composition e.g., at least about 95 wt %, or at least about 97 wt %, or at least about 98 wt %, or at least about 99 wt % of the sweetener composition.

In some embodiments, the sweetener compositions of the disclosure further comprises one or more mogrosides. For example, these mogrosides may be provided in a composition substantially free of other Siraitia grosvenorii extract components. In some embodiments, one or more mogrosides are selected from mogroside II A₁, mogroside II B, mogroside II E, mogroside III, mogroside III A₂, mogroside IV, mogroside V, mogroside VI, 11-oxo-mogroside V, 7-oxo-mogroside V, isomogroside V, and mixtures thereof. In some embodiments, mogroside is mogroside V.

In one embodiment, the composition comprises one or more mogrosides is present in amount of about 0.02 to about 2.7 wt % based on the total weight of the composition. For example, in certain embodiments, the one or more mogrosides is present in amount of about 0.05 to about 2.7 wt %; or about 0.05 to about 2.5 wt %; or about 0.05 to about 2 wt %; or about 0.05 to about 1.5 wt %; or about 0.05 to about 1 wt %; or about 0.1 to about 2.7 wt %; or about 0.1 to about 2.5 wt %; or about 0.1 to about 2 wt %; or about 0.1 to about 1.5 wt %; or about 0.1 to about 1 wt %; or about 0.5 to about 2.7 wt %; or about 0.5 to about 2.5 wt %; or about 0.5 to about 2 wt %; or about 0.5 to about 1.5 wt %; or about 0.5 to about 1 wt %; or about 1 to about 2.7 wt %; or about 1 to about 2.5 wt %; or about 1 to about 2 wt %; or about 1 to about 1.5 wt %; or about 1.5 to about 2.7 wt %; or about 1.5 to about 2.5 wt %; or about 1.5 to about 2 wt %; or about 2 to about 2.5 wt % based on the total weight of the composition.

In some embodiments, the weight ratio of steviol glycoside to mogrosides is between about 15:1 to about 1:2, or about 15:1 to about 1:1, or about 10:1 to about 1:2, or about 10:1 to about 1:1, or about 5:1 to about 1:2, or about 5:1 to about 1:1, or about 2:1 to about 1:2, or about 2:1 to about 1:1, or about 1:1 to about 1:2.

In some embodiments, the combined content of one or more steviol glycosides, one or more of mogrosides, and one or more syrups is at least about 91% by weight of the sweetener composition e.g., at least about 92 wt %, or at least about 95 wt %, at least about 97 wt %, or at least about 98 wt %, or at least about 99 wt % of the sweetener composition.

The sweetener compositions of the disclosure have sweetness equivalent to about 2 grams to about 19 grams of sucrose, or about 2 grams to about 18 grams of sucrose, or about 2 grams to about 17 grams of sucrose, per 1 gram of the sweetener composition.

The sweetener compositions of the disclosure are clear and/or stable for an extended period of time. More specifically, the sweetener compositions remain clear for extended periods of time (e.g., more than 30 days, more than 60 days, or even more than 90 days) after the composition has been prepared.

In certain embodiments, the clarity and stability of the disclosed compositions is achieved without the addition of stabilizers, e.g., antimicrobial agents, antioxidants, or solvents, such as ethanol or propylene glycol. As a consequence, the compositions disclosed herein are preferably free of such materials.

Thus, in one embodiment, the sweetener composition is substantially free of other additives. As used herein the term “substantially free of,” with respect to a particular ingredients, refers to the particular ingredient being present in a concentration less than is necessary for the ingredient to be effective to provide the benefit or property for which it otherwise would be used, for example, about 0.5 wt % or less, or about 0.1 wt % or less, or about 0.05 wt % or less (based on the total weight of the sweetener composition).

The disclosure also provides methods for preparing the sweetener compositions of the disclosure. For example, in one embodiment, such methods include
(a) providing an aqueous solution comprising about 5-45% by weight of one or more steviol glycosides and about 1-27% by weight of one or more of mogrosides; and
(b) adding the aqueous solution to a syrup.

In another embodiment, such methods include
(a) providing an aqueous solution comprising about 5-45% by weight of one or more steviol glycosides and about 5-45% by weight of Siraitia grosvenorii fruit extract; and
(b) adding the aqueous solution to a syrup.

The aqueous solution is added at the room temperature or elevated temperature to the syrup and the resulting mixture blended until homogenous.

The methods of the disclosure may be performed wherein adding in (b) is a gradual addition with continuous stirring. Such stirring may be sufficient to obtain a homogeneous solution of the sweetener composition. For example, the stirring speed and duration may be adjusted to provide a homogeneous solution of the sweetener composition.

### Definitions

The following terms and expressions used have the indicated meanings.

Throughout this specification, unless the context requires otherwise, the word “comprise” and “include” and variations (e.g., “comprises,” “comprising,” “includes,” “including”) will be understood to imply the inclusion of a stated component, feature, element, or step or group of components, features, elements or steps but not the exclusion of any other integer or step or group of integers or steps.

As used in the specification and the appended claims, the singular forms “a,” “an,” and “the” include plural referents unless the context clearly dictates otherwise.

As used herein, the term “about” refers to the given value ±10% of the value.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

All percentages, ratios and proportions herein are by weight, unless otherwise specified. A weight percent (weight %, also as wt %) of a component, unless specifically stated to the contrary, is based on the total weight of the composition in which the component is included (e.g., on the total amount of the compositions).

### EXAMPLES

The methods of the disclosure are illustrated further by the following examples, which are not to be construed as limiting the disclosure in scope or spirit to the specific procedures and in them.

### Example 1: Stability Study

Materials:

Two stevia leaf extracts obtained from PureCircle (Kuala Lumpur, Malaysia) were used in this test along with a 50 wt % Mogroside V monk fruit extract obtained from Monk Fruit Corporation (Libertyville, Ill.). “Delta” is a stevia leaf extract comprising approximately 54% Reb-D, 41% Reb-A, and 5% Reb-B. “Reb-M” is a stevia leaf extract comprising approximately 81% Reb-M, 10% Reb-D, 7% Reb-A, and 2% Reb-B. The sweetening potency for both stevia leaf extracts and the monk fruit extract have been assumed to be equivalent.

Compositions:

Aqueous formulations of steviol glycosides and monk fruit extract were prepared: 1) 10 wt % of Delta in water, 2) 5 wt % of Delta and 5 wt % of monk fruit extract in water, 3) 5 wt % Delta in water (as control), 4) 10 wt % of Reb-M in water, 5) 5 wt % of Reb-M and 5 wt % of monk fruit extract in water, and 6) 5 wt % Reb-M in water (as control). 5 wt % steviol glycoside in water compositions were used as controls. Samples were prepared by simply dissolving the solutes under heat (e.g., at a temperature of about 90 to 110° C.) and stirring until completely dissolved.

All samples were evaluated for precipitation in timed increments and pictures were taken of each sample for visual record. Samples were stored in plastic vials at room temperature during test.

Results:

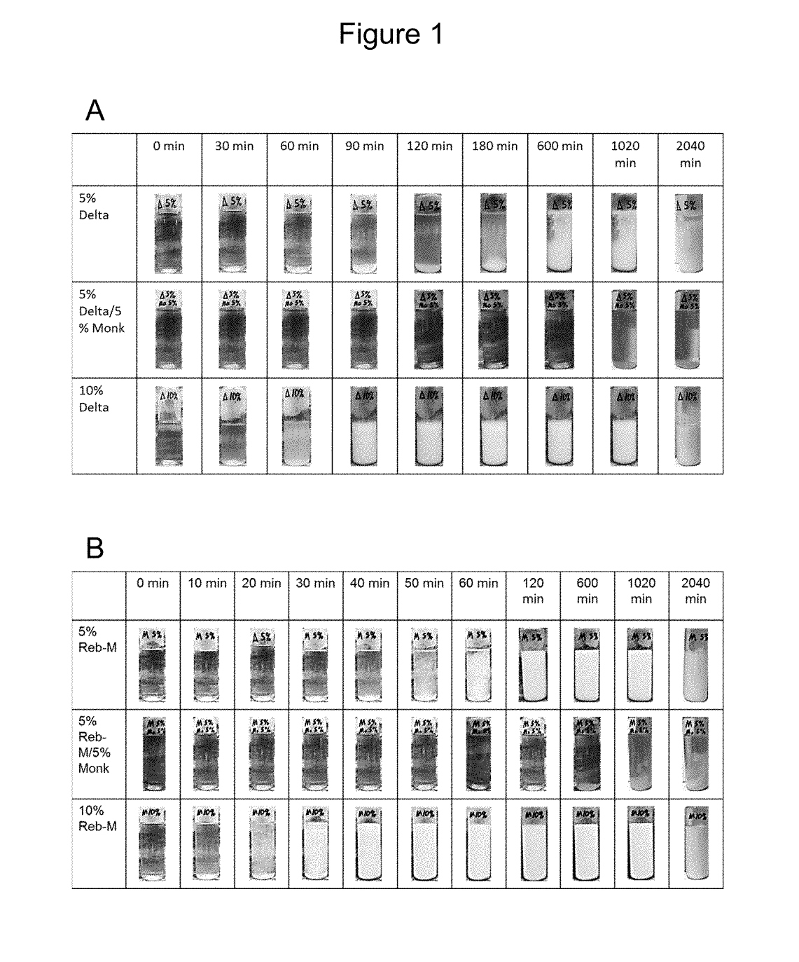

For both Delta and Reb-M steviol glycosides, the use of 5 wt % of monk fruit extract showed significant increase in stability of the solutions and no precipitation. As shown in FIG. 1 A, the 10 wt % Delta composition began showing precipitation within 30 minutes of testing and had reached a thorough breakdown of the supersaturated solution within 90 minutes. The 5 wt % Delta/5 wt % monk fruit extract composition by comparison did not show any signs of precipitation in the first 600 minutes, and even at the final inspection time of 2040 minutes had not yet reached the level of precipitation that was seen at 60 minutes in the 10 wt % Delta composition. In comparison to the control 5 wt % Delta composition, the 5 wt % Delta/5 wt % monk fruit extract composition still showed a significant increase in stability. This was surprising as the 5 wt % Delta/5 wt % monk fruit extract composition was approximately twice as sweet than the control and contained the same 5 wt % level of Delta in composition along with an additional 5 wt % of another solute (monk fruit extract). The Reb-M set of samples exhibited a very similar result as seen with Delta (FIG. 1 B). The presence of monk fruit extract (i.e., 5 wt % Reb-M/5 wt % monk fruit extract composition) showed improved precipitation stability over both the 10 wt % Reb-M composition and the control 5 wt % Reb-M composition.

### Example 2

Samples were prepared according to the formulas described below.

Samples were stored in 40° C./75% RH stability chamber in capped glass vials. Samples were visually evaluated every 4 weeks for any signs of precipitation instability.

“2.2% Stevia/0.8% Monk” contains 2.2% stevia leaf extract and 0.8% monk fruit extract by weight, and formulated to 70% solids with organic agave nectar and added water. Stevia leaf extract is comprised primarily of rebaudiosides A, D, and M, accounting for approximately 50%, 25%, and 25% of the glycoside profile respectively. Monk fruit extract is comprised of approximately 50% Mogroside-V.

“3% Stevia” contains 3% Stevia leaf extract by weight, and formulated to 70% solids with organic agave nectar and added water. Stevia leaf extract is comprised primarily of rebaudiosides A, D, and M, accounting for approximately 50%, 25%, and 25% of the glycoside profile respectively.

“2.2% Stevia” contains 2.2% Stevia leaf extract by weight, and formulated to 70% solids with organic agave nectar and added water. Stevia leaf extract is comprised primarily of rebaudiosides A, D, and M, accounting for approximately 50%, 25%, and 25% of the glycoside profile respectively.

Results:

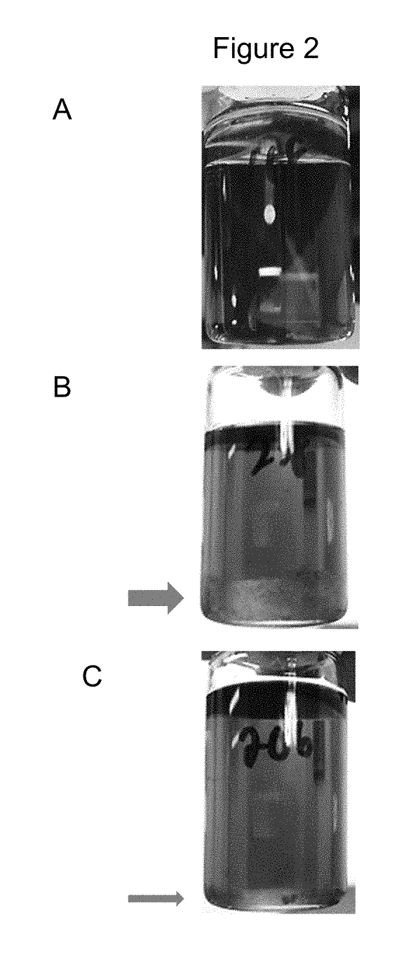

Table 1 below shows the precipitation stability test results for the three formulas stored in 40° C./75% RH over 24 weeks. The samples were rated on a Pass/Fail/“Pass, but instability noted” basis. Fail vs. “Pass, but instability noted” was judged by presence of anything (e.g., cloudiness, ppt, etc.) in the sample upon close inspection. The results demonstrate that the “2.2% Stevia/0.8% Monk” formula performed superiorly to both the “3% Stevia” and “2.2% Stevia” formulas. The comparison to the “3% Stevia” formula serves to show that the target level of sweetness can be attained through using the Monk Fruit Extract in conjunction with the Stevia Leaf Extract blend while remaining free from any precipitation, whereas it is not attainable using the Stevia Leaf Extract blend alone. The evaluation results for the “2.2% Stevia” formula demonstrate that the improvement seen in “2.2% Stevia/0.8% Monk” over “3% Stevia” was not due solely to a decreased level of Stevia Leaf Extract overall. The “2.2% Stevia/0.8% Monk” formula contains the same absolute amount of Stevia Leaf Extract as the “2.2% Stevia” formula, yet performs superiorly in precipitation stability. FIG. 2 shows 24 week pictures of the samples.

TABLE 1

| | Results | | |
|---|---|---|---|
| Week | 2.2% Stevia/0.8% Monk | 3% Stevia | 2.2% Stevia |
| 0 | No Precipitation | No Precipitation | No Precipitation |
| 4 | No Precipitation | No Precipitation | No Precipitation |
| 8 | No Precipitation | 2 small, but noticeable | No Precipitation |
| | | granules present | |
| 12 | No Precipitation | 2 larger granules. 10-15 | No Precipitation |
| | | smaller, but noticeable | |
| | | granules. Slight haze | |
| | | along bottom | |
| 16 | No Precipitation | Significant | Very slight haze along |
| | | sedimentation with large | bottom. Difficult to see |
| | | nucleated particles in | unless inspected closely |
| | | bottom 10% of sample. | up against light. |
| | | Top 90% of sample | |
| | | remains clear. | |
| 20 | No Precipitation | Significant | Slight haze along |
| | | sedimentation with large | bottom. Difficult to see |
| | | nucleated particles in | unless inspected closely |
| | | bottom 20% of sample. | up against light |
| | | Top 80% of sample | |
| | | remains clear | |
| 24 | No Precipitation | Significant | Noticeable precipitate |
| | | sedimentation with large | layer along bottom 5-10% |
| | | nucleated particles in | of sample |
| | | bottom 20% of sample. | |
| | | Top 80% of sample | |
| | | remains clear | |

It is understood that the examples and embodiments described herein are for illustrative purposes only and that various modifications or changes in light thereof will be suggested to persons skilled in the art and are to be incorporated within the spirit and purview of this application and scope of the appended claims. All publications, patents, and patent applications cited herein are hereby incorporated herein by reference for all purposes.

1. A sweetener composition comprising
(a) about 0.1-4.5% by weight of one or more steviol glycosides;
(b) about 0.1-4.5% by weight of Siraitia grosvenorii fruit extract; and
(c) about 90-98% by weight of one or more syrups.

2. A sweetener composition comprising about
(a) about 0.1-4.5% by weight of one or more steviol glycosides;
(b) about 0.02-2.7% by weight of one or more of mogrosides; and
(c) about 90-98% by weight of one or more syrups.

3. (canceled)

4. The sweetener composition of claim 1, wherein the one or more steviol glycosides comprises: rebaudioside A, rebaudioside D, and rebaudioside M.

5. The sweetener composition of claim 4, wherein the ratio of rebaudioside A to the sum of rebaudioside D and rebaudioside M is about 1:1 to about 3:1.

6. The sweetener composition of claim 4 or 5, wherein rebaudioside A is present in about 50% to about 75% by weight based on the total weight of rebaudioside A, rebaudioside D, and rebaudioside M.

7. The sweetener composition of claim 4, wherein rebaudioside D is present in about 7.5% to about 35% by weight based on the total weight of rebaudioside A, rebaudioside D, and rebaudioside M.

8. The sweetener composition of claim 4, wherein rebaudioside M is present in about 7.5% to about 35% by weight based on the total weight of rebaudioside A, rebaudioside D, and rebaudioside M.

9. The sweetener composition of claim 4, wherein the ratio of rebaudioside A to rebaudioside D to rebaudioside M is about 10:2.4:3.

10. The sweetener composition of claim 4, wherein the total amount of rebaudioside A, rebaudioside D, and rebaudioside M is at least about 95 wt % of the rebaudioside composition.

11. (canceled)

12. (canceled)

13. The sweetener composition of claim 1, wherein the syrup is selected from the group consisting of agave syrup, inverted sugar syrup, sugarcane syrup, honey, maple syrup, almond syrup, banana syrup, blueberry syrup, cherry syrup, coconut syrup, hazelnut syrup, kiwi syrup, lemon syrup, mango syrup, orange syrup, peach syrup, strawberry syrup, vanilla syrup, raspberry syrup, apple syrup, blackberry syrup, pineapple syrup, molasses, and mixtures thereof.

14. The sweetener composition of claim 13, wherein the syrup is agave syrup, inverted sugar syrup, sugarcane syrup, honey, coconut syrup, maple syrup, and mixtures thereof.

15. The sweetener composition of claim 13, wherein the syrup is agave syrup.

16. The sweetener composition of claim 13, wherein the syrup is honey.

17. (canceled)

18. (canceled)

19. (canceled)

20. The sweetener composition of claim 1, wherein the weight ratio of one or more steviol glycosides to Siraitia grosvenorii fruit extract is between about 3:1 to about 1:3.

21. (canceled)

22. The sweetener composition of claim 2, wherein mogroside is selected from mogroside II A₁, mogroside II B, mogroside II E, mogroside III, mogroside III A₂, mogroside IV, mogroside V, mogroside VI, 11-oxo-mogroside V, 7-oxo-mogroside V, isomogroside V, and a mixture thereof.

23. The sweetener composition of claim 2, wherein mogroside is mogroside V.

24. (canceled)

25. (canceled)

26. (canceled)

27. The sweetener composition of claim 2, wherein the weight ratio of steviol glycoside to mogrosides is between about 15:1 to about 1:2.

28. (canceled)

29. The sweetener composition of claim 1, wherein 1 gram of the sweetener composition has sweetness equivalent to about 2 grams to about 19 grams of sucrose.

30. The sweetener composition of claim 1, wherein the sweetener composition is substantially homogeneous and clear.

31. A method of making a sweetener composition, wherein the sweetener composition comprises:
(a) about 0.1-4.5% by weight of one or more steviol glycosides;
(b) about 0.1-4.5% by weight of Siraitia grosvenorii fruit extract or about 0.02-2.7% by weight of one or more of mogrosides; and
(c) about 90-98% by weight of one or more syrups,
the method comprising:
(a) providing an aqueous solution comprising about (i) 5-45% by weight of one or more steviol glycosides and (ii) about 5-45% by weight of Siraitia grosvenorii fruit extract or about 1-27% by weight of one or more of mogrosides; and
(b) adding a portion of the aqueous solution to a syrup solution.

32. (canceled)

33. (canceled)
